(19) United States
(12) Patent Application Publication
(10) Pub. No.: US 2006/0131789 A1
(43) Pub. Date: Jun. 22, 2006

(54) Method for recycling coating maskant

(76) Inventors: Sim Mong Hua, Singapore (SG); Marvin Foo Yet Kheng, Johor Bahru (MY); Ranjan A/L Balakrishnan, Johor Bahru (MY); Garimella Balaji Rao, Glendale Park (SG)

Correspondence Address: MCCORMICK, PAULDING & HUBER LLP, CITY PLACE II, 185 ASYLUM STREET, HARTFORD, CT, 06103, US

(21) Appl. No.: 11/017,321

(22) Filed: Dec. 20, 2004

(51) Int. Cl. B29B 7/00; B29C 67/02

(52) U.S. Cl. 264/349

(57) ABSTRACT

A method for recycling maskant is provided that includes the steps of: 1) collecting used maskant agglomerations, each agglomeration having a volumetric size; 2) straining the used maskant agglomerations with a sieve or other straining device; and 3) blending the strained maskant agglomerations, wherein the blending is operable to reduce the volumetric size of the maskant agglomerations. In some embodiments, the present method includes a plurality of blending and straining steps.

### BACKGROUND OF THE INVENTION

1. Technical Field

This invention relates to the use of maskants in coating processes in general, and to methods for recycling used maskants in particular.

2. Background Information

The application of a coating to a portion of a rotor blade within a gas turbine engine is a common manufacturing and repair process. The repairs often require that a maskant be applied to one or more portions of the rotor blade to prevent attachment of the coating materials to those portions of the rotor blade. Once the coating is bonded to the substrate, the maskant is removed. Historically, maskants have been applied once and disposed of after the single use. A person of skill in the art will recognize that maskants are relatively expensive material. Used maskant must also be disposed of properly, consequently creating additional work and cost.

What is needed is a method for recycling used maskant that enables the maskant to be used more than once.

### DISCLOSURE OF THE INVENTION

According to the present invention, a method for recycling maskant is provided that includes the steps of: 1) collecting used maskant agglomerations, each agglomeration having a volumetric size; 2) straining the used maskant agglomerations with a sieve or other straining device; and 3) blending the maskant agglomerations, wherein the blending is operable to reduce the volumetric size of the maskant agglomerations. In some embodiments, the present method includes a plurality of blending and straining steps.

The present method enables maskant to be used more than once. The ability to use the maskant more than once significantly decreases the cost of coating a substrate where a maskant is used. The ability to use the maskant multiple times also significantly reduces the amount of waste materials produced in the coating process. A person of skill in the art will recognize the substantial cost and environmental benefits produced by reduced the amount of waste material generated.

### BRIEF DESCRIPTION OF THE DRAWING

FIG. 1 shows a rotor blade typically used within a gas turbine engine, diagrammatically illustrating maskant applied to the root portion of the airfoil.

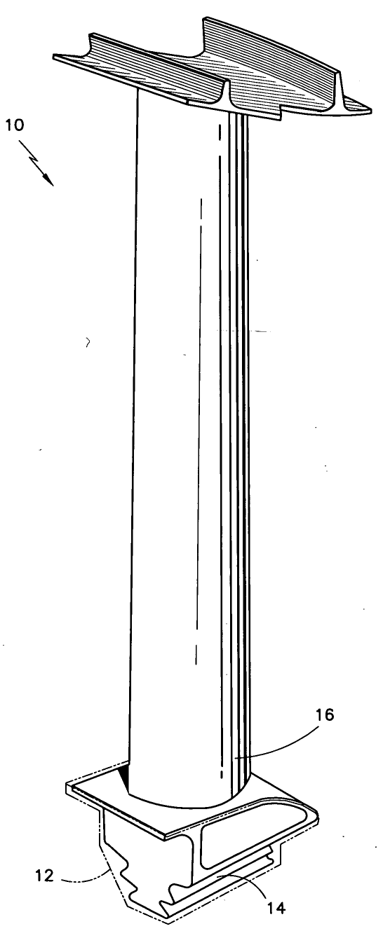

### DETAILED DESCRIPTION OF THE INVENTION

The present method of recycling maskant can be used with any coating process where a maskant is used to prevent the bonding of coating materials to a predetermined portion of a substrate, and where the maskant is not made permanently inoperable as a result of the coating process.

Using the rotor blade 10 shown in the Figure as an example of a substrate, the maskant 12 (shown in phantom) is applied to the root portion 14 of the rotor blade 10 and coating material is applied to the airfoil portion 16 of the rotor blade 10. The rotor blade 10 is subjected to the coating process; e.g., diffusion, etc. After the coating process is completed, excess coating material is preferably removed from the blade 10. The maskant 12 is subsequently removed from the root portion 14 for example by tapping the blade 10 over a collection container. At this point, the used maskant is typically in a variety of different size agglomerations (i.e., “lumps”). The maskant lumps are transferred to a blending apparatus and blended for a predetermined period of time. The blending operation will cause the maskant lumps to decrease in average volumetric size, and thereby become more volumetrically uniform in size.

After the blending step, the blended maskant is transferred to a sieve, or other straining device, of a predetermined size; i.e., a sieve having a plurality of apertures of a first cross-sectional area, or screen mesh of a particular size. The sieve size will depend on the maskant used, and the process at hand. The blended maskant is then strained within the sieve to remove materials of a size small enough to pass through the sieve. Those materials may include contaminants, coating material, and maskant material fines.

Depending upon the maskant material and the coating process, the blended and sieved maskant may be in form acceptable to be reused as maskant. If so, the maskant can then be appropriately stored to be used later according to the normal maskant procedures.

In some applications, however, the blended and sieved maskant is subjected to one or more additional blending steps and straining steps. For example, if a second blending step is desirable, the once blended and strained maskant is transferred to a blending apparatus and blended for second time for a predetermined period of time. Here again, the blending operation will cause the maskant lumps to decrease in average volumetric size, and thereby become more volumetrically uniform in size.

After the second blending step, the blended maskant is transferred to a second sieve of a predetermined size; i.e., a sieve having a plurality of apertures of a second cross-sectional area. The second sieve is finer in size than the first sieve; i.e., the apertures (or screen mesh size) of the second sieve are smaller in cross-sectional area than those of the first sieve. The now twice blended maskant is then strained within the sieve to remove materials of a size small enough to pass through the second sieve.

Depending upon the maskant material and the coating process, the now twice blended and sieved maskant may be in form acceptable to be reused as maskant. If so, the maskant can then be appropriately stored to be used later according to the normal maskant procedures. If not, the blending and sieving steps can be repeated.

The following example is provided to illustrate the present method. The present method is not, however, limited to the materials disclosed within the example.

Maskant, for example M8 brand maskant commercially available from APV Engineered Coatings, 1390 Firestone Parkway, Akron, OH 44301, is applied to the root portion 14 of the rotor blade 10. Coating material, such as an aluminide, is applied to the airfoil portion 16 of the rotor blade 10. The rotor blade 10 is subjected to a coating process wherein the aluminide diffuses into the airfoil substrate. After the coating process is completed, excess coating material is removed from the entire rotor blade 10 by brushing the blade. The maskant is subsequently removed from the blade 10 by tapping the blade over a collection container. The maskant lumps removed from the blade 10 are transferred to a blending apparatus and blended for a predetermined period of time.

After the blending step, the blended maskant is transferred to a four (4) millimeter sieve. The blended maskant is then strained within the sieve to remove materials of a size small enough to pass through the sieve. The material that passes through the sieve is discarded.

The blended and sieved maskant is transferred to a blending apparatus and blended a second time for a predetermined period of time. After the second blending step, the blended maskant is transferred to a 0.100 millimeter sieve and strained to remove materials of a size small enough to pass through the second sieve. The now twice blended and sieved maskant is subsequently removed from the sieve and is stored for later use.

Although this invention has been shown and described with respect to the detailed embodiments thereof, it will be understood by those skilled in the art that various changes in form and detail thereof may be made without departing from the spirit and the scope of the invention. For example, the present invention method includes one or more blending steps and one or more straining steps. The order and number of the blending and straining steps can be altered to satisfy the application at hand, and is not limited to the examples provided herein.

What is claimed is:

1. A method for recycling maskant, comprising the steps of:
collecting used maskant agglomerations;
straining the used maskant agglomerations within a sieve; and
blending the strained maskant agglomerations, wherein the blending is operable to change the strained maskant agglomerations from a first volumetric size to a second volumetric size, which second volumetric size is less than the first volumetric size.

2. A method for recycling maskant, comprising the steps of:
collecting used maskant agglomerations, each agglomeration having a volumetric size;
straining the used maskant agglomerations within a first straining device having a plurality of apertures of a first cross-sectional area;
blending the strained maskant agglomerations, wherein the blending is operable to reduce the volumetric size of the strained maskant agglomerations; and
straining the used maskant agglomerations within a second straining device having a plurality of apertures of a second cross-sectional area, wherein the second cross-sectional area is less than the first cross-sectional area.

3. The method of claim 2, wherein the first and second straining devices are sieves.

4. The method of claim 2, further comprising the step of blending the collected maskant agglomerations prior to the maskant agglomerations being strained, wherein the blending is operable to reduce the volumetric size of the collected maskant agglomerations.

5. A method for recycling maskant, comprising the steps of:
collecting used maskant agglomerations, each agglomeration having a volumetric size;
straining the collected maskant agglomerations;
blending the strained maskant agglomerations, wherein the blending is operable to reduce the volumetric size of the strained maskant agglomerations; and
straining the blended maskant agglomerations.

6. The method of claim 5, further comprising the step of blending the collected maskant agglomerations prior to straining the collected maskant agglomerations.
